(19) United States
(12) Patent Application Publication
(10) Pub. No.: US 2016/0141753 A1
(43) Pub. Date: May 19, 2016

(54) ELECTRONIC DEVICE AND METHOD FOR SELECTING ANTENNA OF ELECTRONIC DEVICE

(71) Applicant: Chiun Mai Communication Systems, Inc., New Taipei (TW)

(72) Inventors: GENG-HONG LIOU, Tu-Cheng (TW); YEN-HUI LIN, Tu-Cheng (TW)

(21) Appl. No.: 14/866,434

(22) Filed: Sep. 25, 2015

(30) Foreign Application Priority Data
Nov. 18, 2014 (CN) 201410656292.4

(51) Int. Cl. H01Q 3/24; H04B 7/04; H04B 1/44

(52) U.S. Cl. CPC H01Q 3/24; H04B 1/44; H04B 7/04

(57) ABSTRACT

In a method for selecting an antenna of an electronic device, one or more sensors are used to detect whether all of the antennas of the electronic device are approached by external objects. When all of the antennas are approached by the external objects, an approached antenna which has a largest value of received signal strength indication is selected. When not all of the antennas are approached by the external objects, an antenna which has a largest value of received signal strength indication and is not approached is selected. The selected antenna is set for transmitting and receiving wireless signals.

### CROSS-REFERENCE TO RELATED APPLICATIONS

This application claims priority to Chinese Patent Application No. 201410656292.4 filed on Nov. 18, 2014, the contents of which are incorporated by reference herein.

### FIELD

The subject matter herein generally relates to antenna technology, and particularly to an electronic device and a method for selecting an antenna of the electronic device.

### BACKGROUND

Several antennas are usually fixed onto different locations of an electronic device for transmitting and receiving wireless signals. The antennas can be approached by an external object, for example, an antenna is weak on transmission wireless signals when the antenna is covered by the external object. When the weak antenna is selected to transmit and receive wireless signals, the antenna is not able to set up a connection with a good quality required and the wireless signals of the antenna may be interrupted during the transmission.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a selection system.

FIG. 2 illustrates a flowchart of one embodiment of a method for selecting an antenna of the electronic device in FIG. 1.

FIG. 3 is a diagram of relative positions between sensors and antennas of the electronic device in FIG. 1.

FIGS. 4A-4D are diagrams of external interference that an external object is applied to antennas of the electronic device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

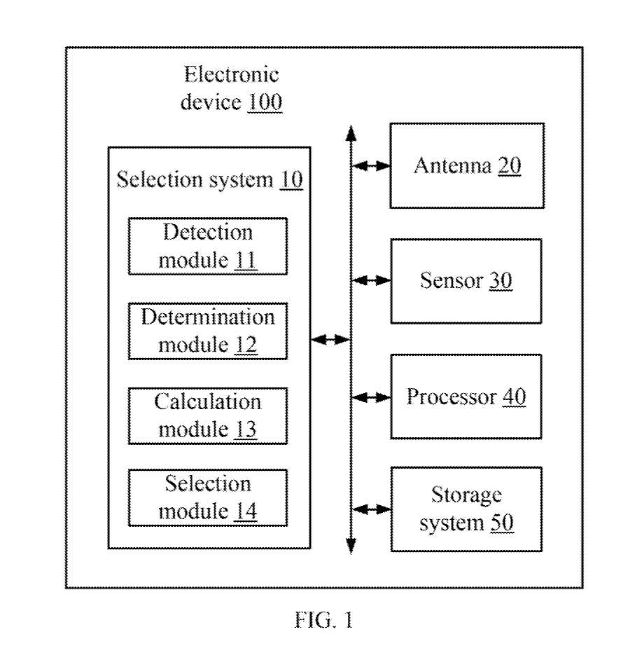

FIG. 1 illustrates a block diagram of one embodiment of an electronic device 100. Depending on the embodiment, the electronic device 100 includes a selection system 10. In one embodiment, the electronic device 100 can be, but is not limited to, a wearable device, such as, a smart watch, a smart bracelet, or smart glasses. The electronic device 100 also can be a mobile device such as a smart phone or a tablet computer. The electronic device 100 further includes, but is not limited to, a plurality of antennas 20 (only one shown), one or more sensors 30 (only one shown), at least one processor 40, and a storage system 50.

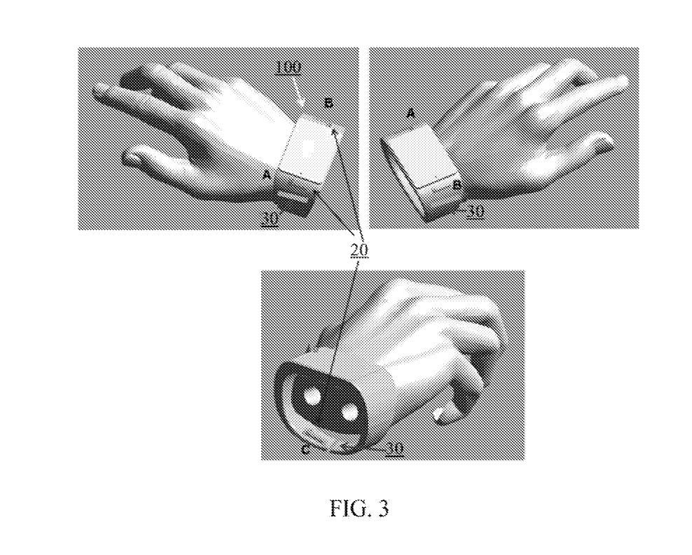

In at least one embodiment, the antennas 20 can be fixed onto different locations of the electronic device 100. For example, the antennas 20 can be fixed onto different locations of an outer side of the electronic device 100, which is a side of the electronic device 100 that is away from a body of a user when the electronic device 100 is worn or held by the user. As an example shown in FIG. 3, when the antennas 20 includes three antennas 20, they can be separately fixed onto a location A, a location B and a location C of the outer side of a wearable device. Distributing the antennas 20 onto different locations of the electronic device 100 can minimize the number of antennas 20 that are affected by nearby external objects. Each of the external objects can be a palm, a wrist, any part of the body of the user, or any object covering the antennas 20.

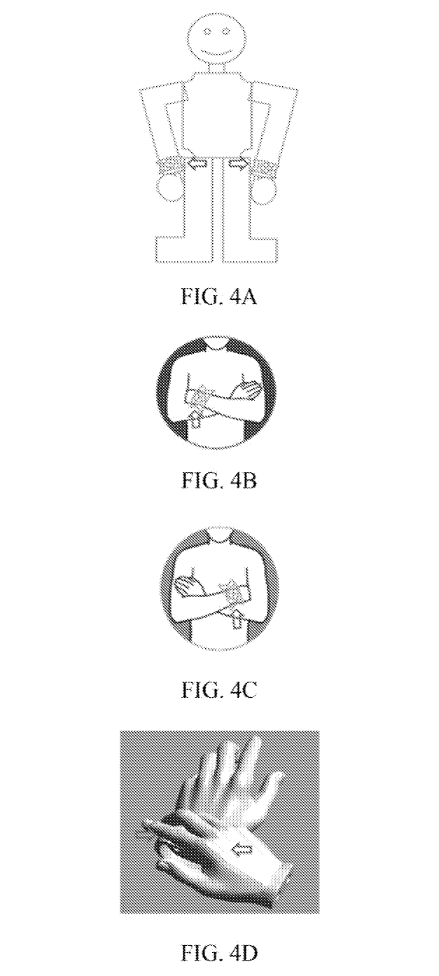

If a distance between an external object and one of the antennas 20 is within a predetermined value, the external object can affect the transmission ability of the antenna 20 and the antenna 20 is regarded as approached by the external object. The transmission ability of the antenna 20 is an ability of the antenna 20 for transmitting and receiving wireless signals. The predetermined value can be determined according to the performance of the antenna 20, for example, one centimeter. As an example shown in FIG. 4A, the external object can affect the transmission ability of the antenna 20 in the location C of the outer side of the electronic device 100. As an example shown in FIG. 4B, the external object can affect the transmission ability of the antenna 20 in the location A of the outer side of the electronic device 100. As an example shown in FIG. 4C, the external object can affect the transmission ability of the antenna 20 in the location B of the outer side of the electronic device 100. As an example shown in FIG. 4D, the external object can affect the transmission ability of the antennas 20 in the locations B and C of the outer side of the electronic device 100.

In at least one embodiment, each sensor 30 can be, but is not limited to, a displacement sensor, a distance sensor, or a proximity sensor. The sensors 30 can be fixed to the outer side of the electronic device 100 near each of the antennas 20 (see in FIG. 3). For each antenna 20, there may be a sensor 30 disposed within a predetermined range of the antenna 20, so that the sensor 30 can detect a distance between an external object and the antenna 20 corresponding to the sensors 30. When the distance between the external object and the antenna 20 corresponding to the sensor 30 is less than the predetermined value, the selection system 10 determines that the external object approaches the antenna 20, and the antenna 20 may be affected.

In at least one embodiment, the storage system 50 can include various types of non-transitory computer-readable storage media. For example, the storage system 50 can be an internal storage system, such as a flash memory, a random access memory (RAM) for temporary storage of information, and/or a read-only memory (ROM) for permanent storage of information. The storage system 50 can also be an external storage system, such as a hard disk, a storage card, or a data storage medium. The at least one processor 40 can be a central processing unit (CPU), a microprocessor, or other data processor chip that performs functions of the electronic device 100.

In at least one embodiment, the selection system 10 is used to select a most stable antenna 20 for transmitting and receiving wireless signals from the antennas 20. The selection system 10 can include a detection module 11, a determination module 12, a calculation module 13, and a selection module 14. The function modules 11-14 can include computerized code in the form of one or more programs, which are stored in the storage system 50. The at least one processor 40 executes the computerized code to provide functions of the function modules 11-14.

The detection module 11 uses the sensors 30 to detect whether the antennas 20 are approached by one or more external objects when an antenna 20 needs to be selected for transmitting and receiving wireless signals.

In at least one embodiment, when the electronic device 100 needs to transmit data or switch to another antenna 20 for transmitting data because of interruption of data transmission, the detection module 11 determines that an antenna 20 needs to be selected. If a sensor 30 detects one or more external objects within a predetermined distance away from the antenna 20 corresponding to the sensor 30, the detection module 11 determines that the antenna 20 is approached by the external objects. If a sensor 30 does not detect any external object within the predetermined distance away from the antenna 20 corresponding to the sensor 30, the detection module 11 determines that the antenna 20 is not approached by the external objects.

The determination module 12 determines whether all antennas 20 of the electronic device 100 are approached by the external objects.

If the all antennas 20 of the electronic device 100 are approached by the external objects, the calculation module 13 calculates a value of received signal strength indication (RSSI) of each of the approached antennas 20. In at least one embodiment, the value of received signal strength indication of each antenna 20 can be calculated according to the existing technology. The value of received signal strength indication of each antenna 20 indicates the ability of each antenna 20 for transmitting and receiving wireless signals. The larger the value of received signal strength indication of an antenna 20 is, the stronger the ability of the antenna 20 for transmitting and receiving wireless signals is.

If only a part of the antennas 20 of the electronic device 100 are approached by the external objects, the calculation module 13 calculates a value of received signal strength indication of each of the antennas 20 which are not approached by the external objects.

The selection module 14 selects an antenna 20 from the calculated antennas 20 based on the calculated RSSI value, and set the selected antenna 20 for transmitting and receiving wireless signals. In at least one embodiment, the selected antenna 20 has a largest value of received signal strength indication of the calculated antennas 20. In detail, when all antennas 20 are approached by external objects, the selected antenna 20 is the antenna 20 which has a largest value of received signal strength indication. When only a part of the antennas 20 is approached by the external objects, the selected antenna 20 is an unapproached antenna 20 which has a largest value of received signal strength indication.

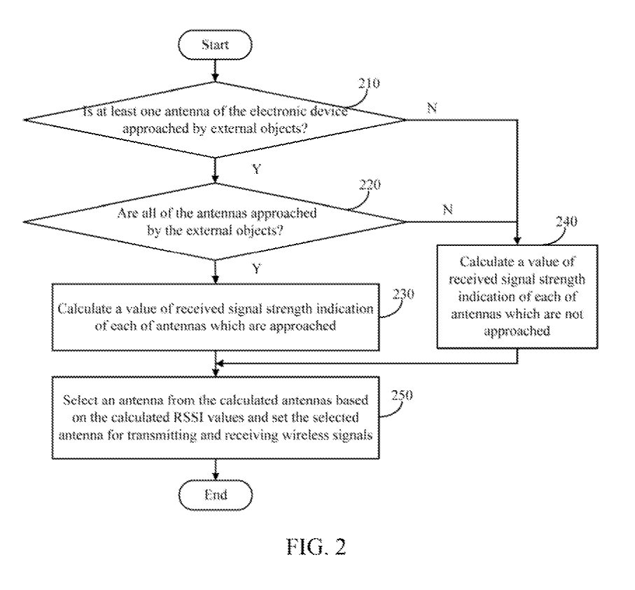

Referring to FIG. 2, a flowchart is presented in accordance with an example embodiment. The example method is provided by way of example, as there are a variety of ways to carry out the method. The method described below can be carried out using the configurations illustrated in FIG. 1, for example, and various elements of the figure are referenced in explaining example method. Each block shown in FIG. 2 represents one or more processes, methods, or subroutines, carried out in the exemplary method. Furthermore, the illustrated order of blocks is by example only and the order of the blocks can be changed. Additional blocks may be added or fewer blocks may be utilized, without departing from this disclosure. The exemplary method can begin at block 210. Depending on the embodiment, additional blocks can be added, others removed, and the ordering of the blocks can be changed.

At block 210, when an antenna of an electronic device needs to be selected for transmitting and receiving wireless signals, a detection module uses one or more sensors of the electronic device to detect whether at least one antenna of the electronic device is approached by external objects. If at least one antenna is approached by the external objects, block 220 is implemented. If no antenna is approached by the external objects, block 240 is implemented.

At block 220, a determination module determines whether all of the antennas are approached by the external objects. If all of the antennas are approached by the external objects, block 230 is implemented. If only a part of the antennas is approached by the external objects, block 240 is implemented.

At block 230, a calculation module calculates a value of received signal strength indication of each of the approached antenna. In at least one embodiment, the value of received signal strength indication of the antenna can be calculated according to the existing technology. The value of received signal strength indication of each antenna indicates the ability of each antenna for transmitting and receiving wireless signals.

At block 240, the calculation module calculates a value of received signal strength indication of each of the antennas which are not approached by the external objects.

At block 250, a selection module selects an antenna from the calculated antennas based on the calculated RSSI values, and sets the selected antenna for transmitting and receiving wireless signals. The selected antenna may be an approached antenna which has a largest value of received signal strength indication when all antennas are approached by external objects. The selected antenna may be an unapproached antenna which has a largest value of received signal strength indication when only a part of the antennas is approached by external objects.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for selecting an antenna of an electronic device comprising one or more sensors and a plurality of antennas, the method comprising:
using the one or more sensors to detect whether all of the antennas are approached by one or more external objects;
calculating a value of received signal strength indication of each of the antennas which are not approached when not all of the antennas are approached by one or more external objects;
selecting an antenna from the antennas which are not approached based on the calculated value; and
setting the selected antenna for transmitting and receiving wireless signals.

2. The method according to claim 1, the method further comprising:
calculating the value of received signal strength indication of each of the antennas when all of the antennas are approached by one or more external objects;
selecting one of the antennas based on the calculated value; and
setting the selected antenna for transmitting and receiving wireless signals.

3. The method according to claim 1, the method further comprising:
calculating the value of received signal strength indication of each of the antennas when none of the antennas is approached by one or more external objects;
selecting one of the antennas based on the calculated value; and
setting the selected antenna for transmitting and receiving wireless signals.

4. The method according to claim 1, the method further comprising:
determining a said antenna as approached by external object when a said sensor corresponding to the said antenna detects an external object within a predetermined distance away from the said antenna; and
determining the said antenna as not approached by external object when the said sensor corresponding to the said antenna does not detect any external object within the predetermined distance away from the said antenna.

5. The method according to claim 1, wherein the selected antenna has the largest value of received signal strength indication among the calculated antennas.

6. An electronic device for selecting an antenna, the electronic device comprising:
a plurality of antennas;
at least one processor;
one or more sensors fixed near the antennas; and
a storage system that stores one or more programs, when executed by the at least one processor, cause the at least one processor to perform operations comprising:
using the one or more sensors to detect whether all of the antennas are approached by one or more external objects;
calculating a value of received signal strength indication of each of the antennas which are not approached when not all of the antennas are approached by one or more external objects;
selecting an antenna from the antennas which are not approached based on the calculated value; and
setting the selected antenna for transmitting and receiving wireless signals.

7. The electronic device according to claim 6, wherein the operations further comprise:
calculating the value of received signal strength indication of each of the antennas when all of the antennas are approached by one or more external objects;
selecting one of the antennas based on the calculated value; and
setting the selected antenna for transmitting and receiving wireless signals.

8. The electronic device according to claim 6, wherein the operations further comprise:
calculating the value of received signal strength indication of each of the antennas when none of the antennas is approached by one or more external objects;
selecting one of the antennas based on the calculated value; and
setting the selected antenna for transmitting and receiving wireless signals.

9. The electronic device according to claim 6, wherein the operations further comprise:
determining a said antenna as approached by external object when a said sensor corresponding to the said antenna detects an external object within a predetermined distance away from the said antenna; and
determining the said antenna as not approached by external object when the said sensor corresponding to the said antenna does not detect any external object within the predetermined distance away from the said antenna.

10. The electronic device according to claim 6, wherein the selected antenna has the largest value of received signal strength indication among the calculated antennas.

11. A non-transitory storage medium having stored thereon instructions that, when executed by a processor of a electronic device comprising one or more sensors and a plurality of antennas, causes the processor to perform a method for selecting an antenna of the electronic device, wherein the method comprises:
using the one or more sensors to detect whether all of the antennas are approached by one or more external objects;
calculating a value of received signal strength indication of each of the antennas which are not approached when not all of the antennas are approached by one or more external objects;
selecting an antenna from the antennas which are not approached based on the calculated value; and
setting the selected antenna for transmitting and receiving wireless signals.

12. The non-transitory storage medium according to claim 11, wherein the method further comprises:
calculating the value of received signal strength indication of each of the antennas when all of the antennas are approached by one or more external objects;
selecting one of the antennas based on the calculated value; and
setting the selected antenna for transmitting and receiving wireless signals.

13. The non-transitory storage medium according to claim 11, wherein the method comprises:
calculating the value of received signal strength indication of each of the antennas when none of the antennas is approached by one or more external objects;
selecting one of the antennas based on the calculated value; and
setting the selected antenna for transmitting and receiving wireless signals.

14. The non-transitory storage medium according to claim 11, wherein the method comprises:
determining a said antenna as approached by external object when a said sensor corresponding to the said antenna detects an external object within a predetermined distance away from the said antenna; and
determining the said antenna as not approached by external object when the said sensor corresponding to the said antenna does not detect any external object within the predetermined distance away from the said antenna.

15. The non-transitory storage medium according to claim 11, wherein the selected antenna has the largest value of received signal strength indication among the calculated antennas.
